(19) United States
(12) Patent Application Publication
(10) Pub. No.: US 2016/0034641 A1
(43) Pub. Date: Feb. 4, 2016

(54) NETWORK-BASED SYSTEMS AND METHODS FOR PROVIDING PATIENT SUBSCRIPTION STATUS

(71) Applicant: Audacious Inquiry, Catonsville, MD (US)

(72) Inventors: Sandeep Antony, Columbia, MD (US); Scott Afzal, Washington, DC (US); Genevieve Morris, Laurel, MD (US); Christopher Brandt, Baltimore, MD (US)

(21) Appl. No.: 14/445,562

(22) Filed: Jul. 29, 2014

(51) Int. Cl. G06F 19/00; G06Q 50/24

(52) U.S. Cl. CPC G06F 19/322; G06Q 50/24

(57) ABSTRACT

Networks and methods include or use a computer hardware processor to manage healthcare information between healthcare information providers and subscribers. Subscriber and provider requests are used in the networks and methods to provide only responsive content to subscribers and providers. Providers may receive content that identifies the subscribers to patients in requests from providers or in healthcare messages from providers. Networks and methods screen healthcare with criteria in the requests, and only when the information matches the criteria, provides a deliverable based on the healthcare information, in desired format and fashion, to the subscriber or provider associated with the matching criteria. Systems and methods are configured to receive requests, healthcare information, and other parameters directly from subscribers and providers, as well through intermediaries. The received and provided content can be formatted for processing and selective transmission, including HL7 and CCDA-type summary of care documents sent over several different interfaces.

### BACKGROUND

Healthcare information, including patient medical records and activities, facility encounters, insurance information, provider institutions, billing data, government healthcare support information, etc., across a large population can be aggregated in a Health Information Exchange (HIE) or similar database. For example, providers, insurers, and/or or governmental bodies may gather relevant healthcare information for all patients, providers, insurers, and other healthcare actors in exchanges. An example of a related art HIE may be Maryland's CRISP network and associated Master Patient Index (MPI). FIG. 1 is an illustration of a related health information exchange system 10. As shown in FIG. 1, system 10 includes a HIE 15 having a healthcare information routing and demographic matching structure 30, healthcare information database 21, and a healthcare information logic structure 20.

Healthcare information routing and demographics matching structure 30 may be a digitized or computer-based system that facilitates entry, gathering, and organization of healthcare information from one or more providers 50. For example, providers 50 may be emergency rooms, outpatient clinics, urgent care offices, pharmacies, laboratories, assisted living facilities, visiting nurse networks, etc. Providers 50 typically provide a variety of healthcare information to HIE 15 via healthcare information routing and demographics matching structure 30. For example, a provider 50 may provide clinical feeds 36, patient Admit-Discharge-Transfer (ADT) messages 35 in a known HL7 standard format, and/or any other healthcare information to healthcare information routing and demographics matching structure 30. The healthcare information, including content from clinical feeds 36 and ADT messages 35, may include many different types of relevant healthcare information, including patient biographical information, treatment, other medical history, insurance information, provider activities, lab results, charges for services, etc. that typically reflect healthcare information on a per patient basis. Particularly, ADT messages 35 may be generated and transmitted any time a patient has an encounter with a hospital 50, such as an admittance, discharge, transfer, to/from/within a hospital, and ADT messages 35 include this encounter information.

As shown in FIG. 1, healthcare information routing and demographics matching structure 30 may include an interface or router 32 that receives clinical feeds 36 and/or ADT messages 35 from hospitals 50. The router 32 may process or otherwise prepare data for entry into a database 21 and associated master patient index 31, which matches patient identifying information with content of database 21 to reconcile patient identity within health information exchange 15.

Subscribing participants 60 may access healthcare information stored in database 21 as indexed by master patient index 31 through healthcare information logic structure 20 in health information exchange 15 that is interfaced with healthcare information routing and demographics matching structure 30. Subscribing participants 60 may be, for example, physicians needing comprehensive healthcare information regarding patients who present at urgent care.

Two mechanisms may be provided in system 10 to provide information to subscribing participants 60. In one instance, subscribing participants 60 can login or otherwise access healthcare information logic structure 20 through a query portal 25. Subscribing participants 60 can enter queries 26 into portal 25, which is interfaced with healthcare information logic structure 20. Logic structure 20 may properly gather and/or associate data from database 21 with master patient index 31 based on the parameters of query 26 and any access/information rules applicable to system 10. In another instance, subscribing participants 60 may be delivered direct notifications 27, such as via email or alert every time an ADT message 35 or other healthcare update occurs to a patient.

### SUMMARY

Example methods and embodiments manage healthcare information in computer-based networks between healthcare sources and subscribers. Example methods can include transmitting subscriber requests and source requests to a healthcare notification system with a computer processor and associated transient memory and possibly persistent memory as well. The subscriber and source requests can include several different criteria for how and what information should be provided to subscribers and sources by the system. When receiving healthcare information from a source, such as clinical treatment data and HL7 ADT messages, the system can perform a variety of functions that result in only responsive content provided to subscribers and back to sources. Such content to a source may include an identity of, or other information about, subscribers to a patient in healthcare information and/or request submitted by a source. Example systems may filter healthcare information against criteria in the requests, like patient biographical information, encounter types, or provider identity. Only when the information matches the criteria may it be provided, in desired format and fashion, to the subscriber or source who submitted the criteria.

### BRIEF DESCRIPTIONS OF THE DRAWINGS

Example embodiments will become more apparent by describing, in detail, the attached drawings, wherein like elements are represented by like reference numerals, which are given by way of illustration only and thus do not limit the example embodiments herein.

FIG. 1 is an illustration of a related art health information exchange system.

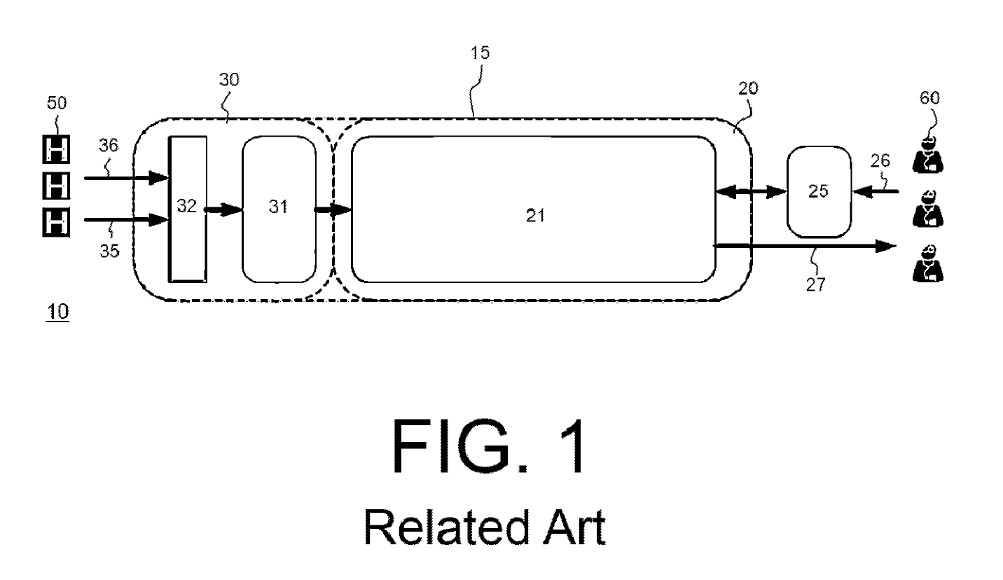

FIG. 2 is an illustration of an example embodiment healthcare notification system.

FIG. 3 is a flowchart of an example method of providing filtered healthcare notifications.

### DETAILED DESCRIPTION

This is a patent document, and general broad rules of construction should be applied when reading it. Everything described and shown in this document is an example of subject matter falling within the scope of the claims, appended below. Any specific structural and functional details disclosed herein are merely for purposes of describing how to make and use example embodiments. Several different embodiments not specifically disclosed herein may fall within the claim scope; as such, the claims may be embodied in many alternate forms and should not be construed as limited to only example embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when element(s) are referred to in relation to one another, such as being “connected,” “coupled,” “mated,” “attached,” or “fixed” to another element(s), the relationship can be direct or with other intervening elements. In contrast, when an element is referred to as being “directly connected” or “directly coupled” to another element, there are no intervening elements present. Other words used to describe the relationship between elements should be interpreted in a like fashion (e.g., “between” versus “directly between,” “adjacent” versus “directly adjacent,” etc.). Similarly, a term such as “connected” for communications purposes includes all variations of information exchange routes between two devices, including intermediary devices, networks, etc., connected wirelessly or not.

As used herein, the singular forms “a”, “an,” and “the” are intended to include both the singular and plural forms, unless the language explicitly indicates otherwise with terms like “only a single element.” It will be further understood that the terms comprises,” “comprising,” “includes,” and/or “including,” when used herein, specify the presence of stated features, values, steps, operations, elements, and/or components, but do not themselves preclude the presence or addition of one or more other features, values, steps, operations, elements, components, and/or groups thereof.

It should also be noted that the structures and operations discussed below may occur out of the order described and/or noted in the figures. For example, two operations and/or figures shown in succession may in fact be executed concurrently or may be executed in the reverse order, depending upon the functionality/acts involved. Similarly, individual operations within example methods described below may be executed repetitively, individually or sequentially, so as to provide looping or other series of operations. It should be presumed that any embodiment having features and functionality described below, in any workable combination, falls within the scope of example embodiments.

The following co-owned applications are incorporated by reference herein in their entireties: U.S. application Ser. No. 13/844,332 to Antony et al. filed Mar. 15, 2013; U.S. application Ser. No. 14/142,625 to Antony et al. filed Dec. 27, 2013; U.S. application Ser. No. 14/189,225 to Antony et al. filed Mar. 14, 2014; U.S. application Ser. No. 14/189,278 to Antony et al. filed Mar. 14, 2014; and U.S. application Ser. No. 14/189,306 to Antony et al. filed Mar. 14, 2014. Moreover, the example methods and embodiments of the incorporated documents are useable in whole and in part in addition to, or in replacement of, example systems and methods, including individual components, elements, structures, steps, connections, actions, data structures, functionalities, etc. thereof.

The inventors have recognized that existing healthcare notification systems do not have a method for accurately and consistently alerting relevant healthcare stakeholders, such as providers and payers, when patients, members, and/or citizen populations experience healthcare encounters. Existing systems may use information contained within an ADT message itself to route an alert to the appropriate recipient; however, ADT data often contains errors because it is commonly recorded by hand and relies on the information a patient relays at registration, sometimes under duress at an emergency room. Further, patients often do not provide or know all relevant information or may give incorrect information. The inventors have further recognized that existing systems may pass all ADT messages directly to providers identified therein, resulting in overwhelming volume and irrelevancy of information provided. This may cause recipients to become fatigued by constant and/or low-value messaging, resulting in less useful information for care management realized by existing systems.

The inventors have further recognized that other, more accurate sources of patient and healthcare information may be possessed by healthcare providers, insurers, governments, and other bodies not immediately performing healthcare services. This more accurate information can be solicited from providers as a means for filter messaging and also improve message content. Related art systems may not fully take advantage of the synergy between different healthcare information sources and providers to so enhance information delivery. Moreover, related art systems may not be sufficiently configured to connect and receive information from several different healthcare information sources. The below disclosure uniquely overcomes these and other problems recognized by the inventors in healthcare information networks.

The present invention is computer networks, software, and/or hardware that receive healthcare information and subscriber information and selectively provided. In contrast to the present invention, the few example embodiments and example methods discussed below illustrate just a subset of the variety of different configurations that can be used as and/or in connection with the present invention.

### Example Embodiments

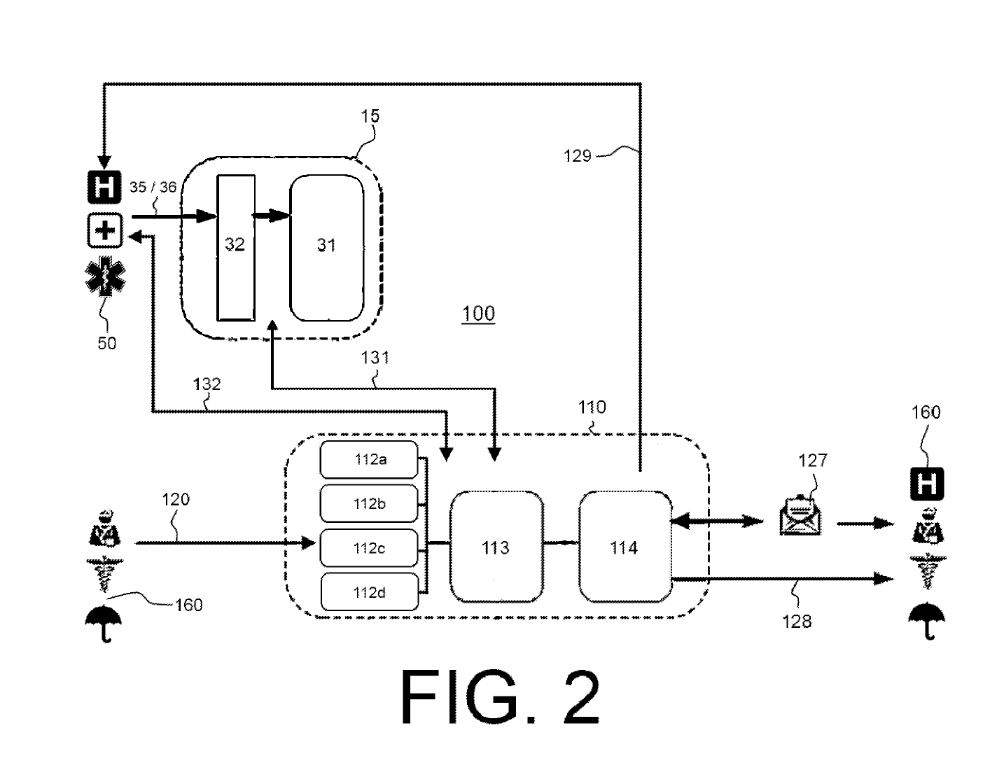

FIG. 2 is a diagram of an example embodiment healthcare notification system 100 that can be physically and logically configured through proper hardware infrastructure and/or software programming to provide targeted healthcare notifications and/or execute example methods of providing healthcare information. As shown in FIG. 2, example embodiment healthcare notification cluster 110 may be connected to a source of healthcare information, like a health information exchange (HIE) 15 and/or a healthcare provider 50 in example embodiment system 100. Healthcare notification cluster 110 and the source may be co-located or remote, and may be connected via a dedicated connection or bus in a same setting or over great distances through networks such as VPNs, WANs, LANs, or the Internet, including TCP/IP and email exchanges.

Although example embodiment healthcare notification system 100 includes HIE 15 and actual providers 50 as healthcare information sources, it is understood that other types of sources for healthcare information are useable with example embodiments and methods. For example, a healthcare provider network system or other database having different data and interface configuration may be used in place of HIE 15. Still further, HIE 15 could be fully contained within healthcare notification cluster 110 to provide a centralized system for receiving, storing, processing, and/or delivering desired healthcare information to various subscribing providers 160. HIE 15 and providers 50, like a hospital or specialist clinic, may be equally be remote and operated by a distinct actor, such as a state-operated database.

As shown in FIG. 2, healthcare notification cluster 110 is configured to receive subscriber information including subscriber parameters 120 from subscribing providers 160. Example embodiment healthcare notification system 100 is useable with a wide variety of subscribing providers 160, including primary care physicians, specialists, insurance providers, hospitals, labs, clinics, home healthcare providers, government entities etc. who may want or may be able to provide unique services with specific types of healthcare information, in specific formats, in specific circumstances.

Subscriber parameters 120 define at least some services and/or actions to be provided by example embodiment system 100. For example, subscriber parameters 120 may include a roster of patient information—including hospital identifier, member ID, any names, home address, city, state, zip code, date of birth, gender, ssn, phone numbers, membership status, etc. and/or portions thereof—identifying patients relevant to subscribers 160. For example, patient information submitted in parameters 120 may be associated with patients under the care of, covered by, and/or under the jurisdiction of subscribing providers 160. Other subscriber information may also be transmitted separately and/or as a part of subscriber parameters 120, including subscriber name, type, service level, enterprise or tax identification numbers, etc.

Subscriber parameters 120 may be input and/or updated into healthcare notification cluster 110 through a subscriber login interface, manually from subscriber parameters 120 that are delivered, such as from a spreadsheet via email, and/or automatically generated in cluster 110 based on a ruleset. For example, each subscribing provider 160 may provide subscriber parameters 120 to healthcare notification cluster 110 through any type of communication possible within a computer-processor-based network, including email, direct connection, manual input, etc. Subscribing providers 160 may provide multiple subscriber parameters 120 at signup and/or modify existing subscriber parameters 120, as their patients and needs and desires for healthcare information change.

Healthcare notification cluster 110 may include an input structure 112 to receive, process, and update/store information from subscriber parameters 120 in accordance with a transmission method used in example embodiment cluster 110. Input structure 112 may be, for example, a module or subroutine within healthcare notification cluster 110 or may be a dedicated server with independent processing capability, depending on the configuration of healthcare notification cluster 110. Alternatively, no separate input structure may be used, instead, a common processor and database may execute all functionality of input structures 112 along with all other functionality of healthcare notification cluster 110.

In example embodiment healthcare notification cluster 110 of FIG. 2, several input structures 112a-d can be used, each with storage capability. Input structures 112a-d may be panels individualized to each subscriber 160; that is, each subscriber 160 may have a one-to-one assigned input structure 112x that stores subscription information, including subscriber parameters 120, only for the one assigned subscriber. In this way, an individual subscriber panel 112x can be created and/or updated for each subscriber 160, allowing for modular handling of subscriber information and interaction between subscribers 160 and cluster 110. It is understood that subscriber panels 112a-d may still share a common database or physical storage location, such as with separately-assigned memories, and/or may use different associations between numbers and types of subscribers 160 and input structures 112, aside from the one-to-one association between four subscribers 160 and four panels 112a-d shown in FIG. 2.

Subscriber parameters 120 stored by input structure 112 may include any kind of subscription information. As discussed above, subscriber parameters 120 may set out a roster of responsive client identification and/or a variety of circumstances for which subscribing providers 160 desire healthcare information, including any combination of events or message types based on which to create notifications, frequency of notifications, delivery format, type preferences, etc. For example, parameters 120 may include a limiting set of events or circumstances for which subscribing providers 160 desire healthcare information. Further, subscriber parameters 120 may include healthcare information formatting, delivery options, analysis, and/or enhancement selections. For example, subscriber parameters 120 may provide auto-subscription information to be used in the example method of FIG. 5, or may request additional analysis or methods to be performed by cluster 110.

As further specific examples, a subscribing provider 160 who is a specialist may want only healthcare information relating to patients under the care of the specialist who have an admit-type ADT message 35 created for a condition within the specialist's field of practice; or a subscribing provider 160 who is a large general practice of physicians may want cumulative healthcare information provided only once a month for a particular subset of very active patients; or an insurance provider as a subscribing provider 160 may want to be notified only when a certain type of encounter that reflects a need for patient contact or intervention occurs, such as multiple ER visits for a condition that may be successfully treated in an outpatient setting. All these limiting factors are examples of filters that may be present in subscriber parameters 120.

Alternatively or additionally, subscriber parameters 120 may be automatically generated based on rules of example embodiment system 100, such as for policy compliance or service reasons. For example, a default set of subscriber parameters 120 may be provided for subscribing providers 160 who provide incomplete or incorrect parameters. Or, for example, if a subscribing provider 160 is a hospital, subscriber parameters 120 may be automatically generated for the hospital to include all patients discharged within the past 60 days, either as a desired service or to comply with regulation. Such automatic generation may be performed by example embodiment cluster 110, such as by input structure 112, for example, by analyzing subscriber information, including subscriber parameters 120, for input reflecting a type of subscriber, comparing such input against a stored list of desired parameters based on type of subscriber, and updating/storing subscriber parameters 120 with the additional parameters.

Example embodiment healthcare notification cluster 110 is interfaced with a healthcare information source. For example, cluster 110 may include an HIE interface 131 that is configured to communicate with healthcare information sources, such as MPI 31, HIE interface 32, and/or entire HIE 15. Or, for example, cluster 110 may include a provider connection 132 that is configured to communicate directly with providers 50, like hospitals, doctor's offices, pharmacies, etc. Thus, cluster 110, via logic core 113 and/or a separate interface, may recognize and understand how to retrieve and read specific data structures or information association regimes present within MPI 31, such as client IDs, patient-identifying information, relationships among entries and records, etc., stored in MPI 31.

Similarly, cluster 110, via logic core 113 and/or a separate interface, may recognize and understand how to receive and process healthcare information directly from providers 50 transmitted via direct provider interface 132. As a specific example of healthcare information from a provider 50, a hospital 50 may generate a summary of care document(s) during a patient encounter, like a discharge. The summary of care document may include healthcare information like patient biographical information, insurance information, treatment information, health history, etc., and may be in a standard electronic health record format, like a Consolidated Clinical Document Architecture (CCDA) message. The CCDA message may be sent directly over interface 132, such as via email using Direct protocol or other HIPAA-compliant secure communications. Of course, other information types can be transferred over interface 132—such as all HL7 messages from providers 50, which may be thousands or more of HL7 messages per day, or just ADT messages and general inquiries from providers 50 to cluster 110 for additional functionality. Cluster 110, via logic core 113, an intake module of direct provider interface 132, and/or another interface can recognize and be able to process information in specific data formats and information relationships sent directly from providers 50, including CCDA summary of care documents and HL7 ADT messages, for example.

Although two interfaces 131 and 132 are shown as separate in FIG. 2, this is only to describe functionalities. It is understood that, even using a single interface 132, direct communications from providers 50 may be achieved. For example, interface 131 may be directly accessed by providers 50 in HIE 15, such that provider 50 still directly provides information to cluster 110. Similarly, HIE 15 may itself be wholly or part of a provider 50, and/or wholly or part of cluster 110, such that providers 50 and cluster 110 may assume all functionalities of HIE 15, either shared or exclusively. In these ways, a direct provider interface 132 is may be a single interface 131.

Healthcare notification cluster 110 in example embodiment system 100 may also include a notification engine 114 controlled by logic core 113. As with each component of cluster 114, notification engine may be a functionality wholly programmed in logic core 113 or can be a separate module or even remote serve with its own processor and persistent and transient memory that is programmed or configured hardware to perform notification functionality in accordance with example methods or otherwise.

Notification engine 114 can prepare healthcare notifications from data anywhere in system 100, such as data derived from ADT messages 35, MPI 31, healthcare analysis stored in cluster 110, and/or any other healthcare information. Notification engine 114 may further provide the prepared information in a subscriber notification. Healthcare notifications may be delivered to subscribing providers 160 through a report 127 sent via email, over a direct or secure network, through the Direct standard, in HL7 format, via Internet services, or even hard copy, based on profile information 120 or other rules. Based on the method used, return receipt or other feedback on delivery of report 127 may be received in cluster 110. For example, under Direct protocols, a Direct email message sent to a subscriber 160 containing responsive information from a CCDA received and matched with the subscriber by cluster 110. The receiving subscriber 160 may send a return receipt, such as a Message Disposition Notification, back to the secure Direct email address of cluster 110 acknowledging receipt. Cluster 110 may store such acknowledgement and/or make it available to the original provider 50 that generated the CCDA that ultimately resulted in the notification 127 being sent.

Healthcare notifications may be structured as narratives, tables, spreadsheets, existing encounter formats, etc. by notification engine 114. For example, notification engine 114 may compile and email out a report of all healthcare information received, filtered, and/or formatted by logic core 113. Healthcare notifications may also be prepared and stored with notification engine 114 and provided to subscribing providers 160 only upon their access 128 to healthcare notification cluster 110; a reminder of a new healthcare notification may still be provided in this instance. Still further, a subscribing provider 160 may receive and/or acknowledge notifications via the Direct standard in real-time from notification engine 114, which may store or further process such acknowledgements.

Notification engine 114 may further include a reverse notification interface 129 to provide information back to healthcare providers 50. Although interfaces 129, 131, and 132 are shown as separate structures/connections, it is understood that these interfaces may be shared or even further divided. Interfaces 129, 131, and 132 are shown as separate to illustrate the ability for different types of information and functionalities to be provided among different actors. For example, interfaces 131 and/or 132 may provide relatively quick, low-burden confirmations back to providers 50 in response to receipt of healthcare information. For example, cluster 110, through example methods, may query MPI 31 or provide new information to MPI 31 based on received healthcare information, subscriber parameters 120, internal analysis or records, or other information sources. Or, for example, cluster 110 may acknowledge receipt of healthcare information via return Direct email over interface 132 to providers 50. As seen in FIG. 2, example embodiment system 100 may require only directed front-end interfaces with a healthcare source, like an provider 50 and/or HIE 15, reducing complexity and/or potential for connection error problems that might exist were all other portions of exchange 15 having their own connection to healthcare notification cluster 110 or if a subscriber 160 had to directly deal with and query exchange 15 or several individual providers 50. Of course, such confirmations may be provided by notification engine 114 as well.

Reverse notification interface 129 may permit more rigorous information, such as the results of filtering, correction, compiling, and/or other functions provided by cluster 110, to be provided back to providers 50 from notification engine 114. For example, notification engine 114 may provide the same notifications that subscribers 160 receive back to the healthcare provider 50 that provided the original healthcare message that caused the notification to be generated. Further, notification engine may provide specialized information generated through example methods back to providers 50, including subscriber information, potentially in response to any number of specialized triggers and in any desired format or timeframe.

Logic core 113, direct provider interface 132, HIE interface 131, reverse notification interface 129 and/or any other communications interface configured to communicate with the healthcare information source(s) may be a central routine, specifically-configured processor, and or wholly individual server with storage and processor within healthcare notification cluster 110, for example, depending on the configuration of healthcare notification cluster 110.

Although networked elements of example embodiment system 100 are shown in FIG. 2 as individual components with specific groupings and subcomponents, it is understood that these elements may be co-located in a single device having adequately differentiated data storage and/or file systems and processing configurations. Alternatively, the elements shown in FIG. 2 may be remote and plural, with functionality shared across several pieces of hardware, each communicatively connected at adequate speeds to provide necessary data transfer and analysis, if, for example, more resources or better logistics are available in distinct locations. Given the variety of example functions described herein, healthcare notification cluster 110 may be structured in a variety of ways to provide desired functionality. Other divisions and/or omissions of structures and functionalities 112, 113, and 114 among any number of separate modules, processors, servers are useable with example embodiment system 100, including execution on a single machine or among distant, exclusive servers and processors.

Similarly, although the example embodiment system 100 of FIG. 2 is a system that can be configured with and execute example methods, it is understood that example methods are useable with other network configurations, and system 100 is useable with other methods of healthcare delivery.

Further, connections shown in example embodiment 100 can be over the Internet, including standard communications protocols such as TCP/IP or email, and/or through a programmed application configured to interact with and exchange data in dedicated network or intranet. Servers within example embodiment system 100 may include, for example, conventional domain and/or security and encryption protocols for access and authentication as well as processing capacities to retrieve, deliver, and/or format data for use within example embodiment system 100.

### Example Methods

Based on healthcare information received from a healthcare information source and subscriber information, healthcare notification cluster 110 can collect, compile, enhance, analyze, and/or provide specific and well-tailored healthcare information for subscribing providers 160 and even back to healthcare information sources 15, 50, etc. As shown in FIG. 2, healthcare notification cluster 110 includes a logic core 113 interfaced with and/or controlling operation of HIE 15 as well as interfaced directly with a provider 50, input structure 112 including individual panels 112a-d, and/or notification engine 114. Logic core 113 may coordinate actions of example methods, including healthcare message processing and analysis, retrieval of healthcare information, delivering healthcare information in accordance, enhancement of MPI 31, and/or several other functions discussed further herein.

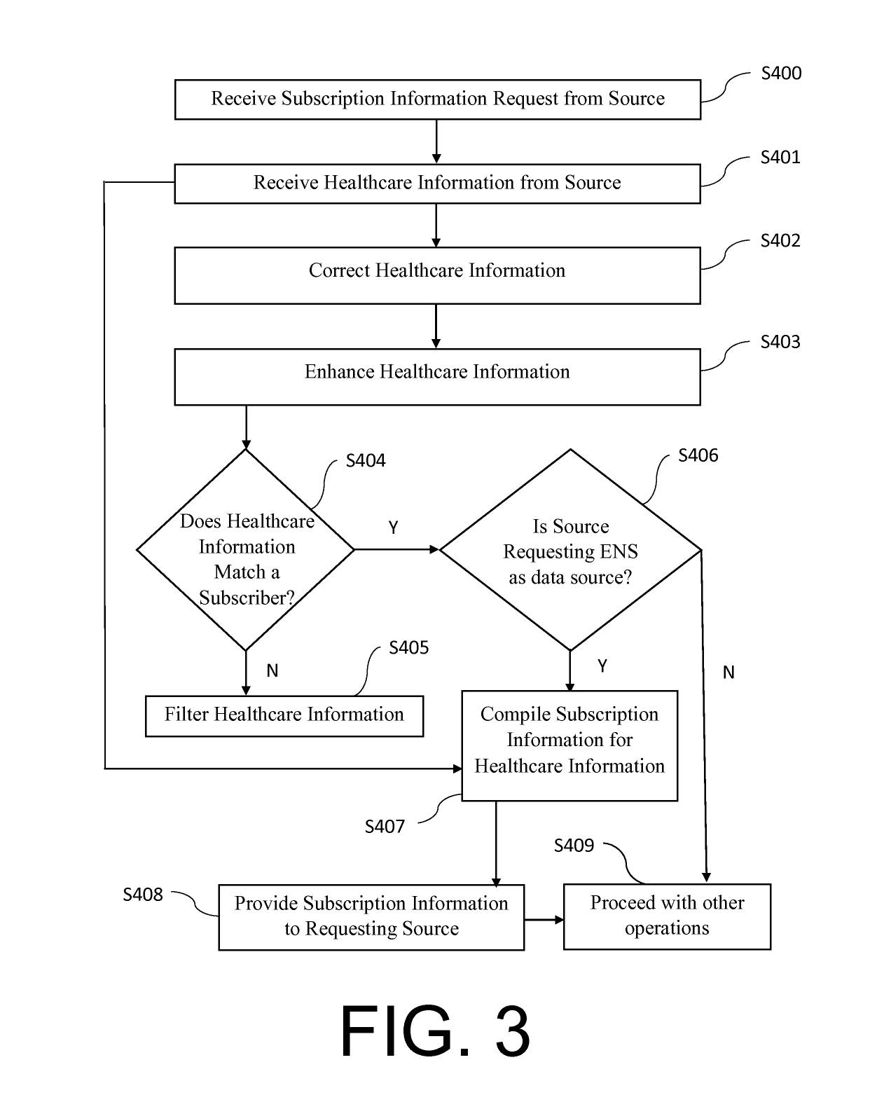

FIG. 3 is a flow chart illustrating an example method of healthcare information and notification processing. Using an example network 100 from FIG. 2, logic core 113 may provide healthcare message processing in the example method of FIG. 3. In S400, an indication may be received from a healthcare source 50, 15—like a hospital, HIE, doctors office, pharmacy, etc.—that the source requests subscription information about a patient. S400 may be executed before, after, and/or in real time with other actions in example methods. In S400, an indication may further include formatting, conditional, processing, and/or other preferences for use in providing information to indicating sources. The indication provided in S400 may be transmitted over any interface 129, 131, 132 or other communication channel to any component of cluster 110.

In S401, healthcare information for a patient or patients may be received from a source. For example, a summary of care document in CCDA format may be generated by a hospital 50 and sent via interface 132, such as an email using the Direct protocol to an email address at cluster 110 compliant with Direct standards. Or, for example, incoming notifications/information to HIE 15 may be monitored and/or received by healthcare notification cluster 110 through interface connection 131. Incoming messages may include standard or enhanced ADT messages 35 or other information from clinical feeds 36, for example. In S401, several messages from several different sources—such as thousands of ADT messages in HL7 format from many different participating hospitals and healthcare providers—may be received, and receiving S401 may include processing and/or storing received healthcare information, for example, to extract relevant patient data from a received CCDA and/or decrypt or arrange data therein based on message type and source configuration. S401 may further include sending a return receipt to the source acknowledging the transmission of the healthcare information.

Although the default rule for all actions, S401 and S400 may occur in any order, given proper persistence of subscriber information and healthcare information in a network executing an example method. S400 and S401 may also be executed simultaneously. For example, when providing healthcare information about a patient, such as a transfer-type ADT message, a provider 50 may further include a request to use cluster 110 as a data source and receive subscription information about a patient depicted in the transmitted transfer ADT. And, of course, S400 may not be executed at all, and it may be a default rule to provide patient subscription information to healthcare information providers whenever they submit eligible healthcare information, regardless of indicator or any request or need.

In S402 and S403, the received healthcare information from S401 can be corrected and/or enhanced, potentially based on the comparison in S404. For example, logic core 113 may further process received ADT messages 35 provided from HIE 15 to discard those messages or portions of messages containing duplicate, incorrect, or low-value contents. For example, a provider 50 may generate an ADT message 35 for an internal transfer that has no meaning outside the provider facilities, or a received healthcare information may include typographical errors in a patient's information or an impossible/redundant administrative status change, such as duplicative admittances for the same patient and facility. Logic core 113 may analyze received healthcare information for such errors, for example, under internal rules for eliminating impossible types of actions, clear typographical errors, or unusable data in S402.

Similarly, in S403, additional information and associations can be added to the healthcare information, based on other information in or available to the enhancer. For example, HIE 15 may autonomously or under the direction or query of logic core 113 associate ADT message 35 or other clinical feed data with other patient information, like record numbers, biographical information, health history information, citizenship records, etc. Such enhancement in S403 may occur automatically before receipt of healthcare information and/or concurrently or after matching and/or correction in example operations.

In S403, if the received healthcare information is a CCDA document received directly from a healthcare provider 50 following a discharge, enhancement from HIE 31 may not be useful, because a provider 50 should be generating such a document after all available information in the CCDA matches that in MPI 31. However, cluster 110 may still detect in S403 whether MPI 31 is for some reason missing information on a patient identified in a received CCDA. In this instance, cluster 110 may enhance MPI 31 by adding the patient from the CCDA into the MPI 31 through, for example, a “patient add” HL7 message. Similarly, cluster 110 may query MPI 31 for any information that may for some reason be missing from CCDA, and use such information to enhance the CCDA.

Additionally or alternatively, logic core 113 may analyze received healthcare information for errors and/or incompleteness by comparing information content against known correct client information, such as the higher-reliability information in subscriber parameters 120. Subscribing providers 160 may be under less duress and/or exercise greater business care in fully and/or properly identifying patients and related healthcare information in their parameters 120. Further, parameters 120 may be curated and re-checked over a history of received messages and other healthcare information, offering a more accurate source of contextual information and data associations therein. Incorrect or useless messages or portions of the information identified in S403 under any approach may be corrected or disposed of without further storage, processing, and/or passing them on to subscribing providers 160. Similarly, incomplete or brief information may be completed or enhanced for more useful analysis and consumption under any approach in S403.

In S404, the received healthcare information in S401 and received subscriber parameters may be compared to determine further treatment of the received healthcare information. In S404, patient-identifying information may be matched against same patient identifying information in provided subscriber parameters. For example, in S404, logic core 113 may compare a patient identifier in a received discharge-type ADT message 35, processed to potentially correct errors, identify fields, and/or enhanced with additional information, against client-identifying information, such as a name, address, patient ID, birthdate, SSN, etc. and/or portions thereof, from a roster processed by input structure 112 from subscriber parameters 120 so as to identify messages relating to a responsive client, e.g., one in a roster from a subscriber. Similarly in S404, logic core 113 may compare extracted information from a message received directly from a provider 50 over interface 132 against subscriber parameters 120.

Logic core 113 may determine which messages are responsive to a provider's roster based on the comparison in S404. Further, because partial information and several different types of healthcare information may be compared in S404, partial or some incorrect information being present in ADT message 35, picked up from MPI 31, incorrectly input into a clinical feed 36, or incompletely transcribed into a CCDA may not prohibit a proper match between received healthcare information and subscription parameters 120.

In S404, if there is a match from the comparison, the matching received information, potentially corrected and/or enhanced from other information in S402 and S403, can be prepared for or forwarded to the matching subscriber. If there is not a match in S404, the received information may be filtered out in S405, by being discarded or otherwise held without being forwarded to a subscriber. For example, in S404, logic core 113 may determine that a received discharge-type ADT message 35 in HL7 standard for a discharge from a specialist facility does not match any subscriber parameter 160, because, for example, the patient in the ADT message is not identified in any rosters stored in input structures 112, and/or because the specialist-discharge event is not matched or is specifically excluded from parameters 120 in input structures 112. In this instance, logic core 113 may not forward the information on to notification engine 114, and no provider may be bothered with the non-matching information. Or for example, logic core 113 may determine that a summary of care document received from a provider 50 matches in relevant part with subscriber parameters 120 for multiple subscribing providers 160. In this instance, logic core 113 may forward the document on to notification engine 114 and/or further process the information to be provided to the multiple matched providers. Or, for example, logic core 113 may determine that received healthcare information from a source is not an admit, transfer, or discharge type message or is of low quality, regardless of subscriber parameters, and appropriately forward or filter the information.

In S406, a request for subscriber information from S400 or S401 is identified, and, if present, in S407, subscription information for matching patients from subscribers may be provided back to the healthcare information source. For example, logic core 113 may identify an indicator that the information source, like HIE 15 or doctor's office 50, requests applicable subscriber information, such as through an explicit separate request in S400 sent over any interface to cluster 110, a combined request with information submission in S401, a standing automatic or default request, etc., for submitted healthcare information. The request may pertain to a single piece of healthcare information, like a patient identified in a discharge-type ADT message, or cover several or larger healthcare informational submissions, like all patients identified in all CCDA documents generated by a pharmacy or every patient having a particular admit-discharge sequence from an emergency room, for example.

In S407, subscription information about responsive patients identified in S406 is compiled for transmission to the requesting healthcare information source. The subscription information may be any information directly from, or about or derived from, subscriber parameters that identify responsive patients. For example, in S207, logic core 113 may identify individual panels 112a-d that include or identify a patient in a submitted piece of healthcare information from source 50, 15, etc., like an ADT message 35 or clinical feed 36, for example. Logic core 113 may then compile the identity of each subscriber 160 that is subscribed to, or will receive a healthcare notification because of, a patient associated with the healthcare information, as well as any other information about the matching subscribers 160, their subscription parameters, other information about the patient causing the match available to cluster 110, etc. While sources 50, 15, etc. may receive subscription information about subscribing providers 160 that have identified same patients identified by sources 50, 15, it is understood that correction and enhancements discussed above may be used to fully associate all healthcare information, subscription parameters, and patients therein, to ensure that sources receive a correct and comprehensive list of subscribing providers 160 that match information provided by sources 50 and/or 15.

Logic core 113 may format and time any subscription information being provided back to healthcare information source 50 or 15 based on the request received in S400. For example, healthcare providers 50 may provide notification limitations with their request for subscription information, such as a special formatting for particular types of encounters and/or patients, additional information to be added to the subscription information, inclusion of any notification 127/128 generated to the subscriber, etc. Logic core 113 may further compare such preferences against the compiled subscriber list to format noncompliant information and forward those complying with provider's request to notification engine 114 to make available to provider 50 in accordance with any other preferences such as delivery format or frequency.

In S407, the compiled, and potentially formatted and enhanced with additional information, list of subscribers for the matching healthcare information is provided back to the originator of the healthcare information. For example, logic core 113 may control notification engine 114 to generate subscription information only at appropriate instances based upon source preferences received in S400. For example, whenever logic core 113 receives a Direct email with a CCDA summary document generated based on a discharge from a hospital 50 that matches in some aspect with subscriber parameters 120, a subscription information transmission, in the form of a Direct-type message to the discharge-generating hospital 50, may be generated by notification engine 114 and transmitted over reverse interface 129. Alternatively, if a healthcare provider 50 requested subscription information only at daily intervals from admit, transfers, and discharges, lists of subscribers whose parameters matched patients in ADTs from hospital 50 may be held until the requested interval has arrived and provided back over a same direct interface 132 to provider 50.

As a more specific example of S400-S408, among thousands of electronic messages, clinical feed data, ADTs, etc. received at cluster 110 from several different sources, an admit-type ADT message in HL7 standard may be received from the Cardiac Specialist Clinic 50 for a specific patient John Doe. Logic core 113 may identify that cluster 112c, associated with subscriber Rainy-Day Insurance Company 160, lists John Doe as a patient that should trigger healthcare notifications to Rainy-Day for admit, transfer, and discharge-type ADTs. Logic core 113 may further determine that Cardiac Specialist Clinic 50 has a standing request for subscription information of all subscribers for patients about whom they submit electronic messages. Logic core 113 may then prepare a list of all subscribers, here including only Rainy-Day 160, and provide the list, potentially with additional identifiers or medical history of John Doe or indication/description of a notification sent to Rainy-Day based on John Doe's received ADT, back to Cardiac Specialist Clinic 50 in a format designated by Cardiac Specialist Clinic 50 over reverse interface 129 from notification engine 114. In this way, Cardiac Specialist Clinic 50 may be able to better determine John Doe's insurance status as well as other relevant medical information like primary care provider, medical history, etc., in a specific and targeted fashion that does not overwhelm Cardiac Specialist Clinic 50 with thousands of pieces of information from potentially different sources.

As shown in FIG. 3, sources may directly request subscription information, regardless of healthcare information transmission or matching in S404. For example, healthcare information providers, like providers 50 and HIEs 15, may be able to directly request subscription information from cluster 110 by simply identifying a patient. Logic core 113 may query panels 112 responsive to a source's direct inquiry for subscription information and return the same, potentially in a requested format and with requested information, over any interface. As long as healthcare sources provide sufficient identifying information, any number of matching subscribers, subscriber parameters, and other information may be provided back to the sources in a simple and direct manner.

Similarly, if a direct or indirect request for subscription information, embedded or separate from provided healthcare information, identifies a patient that does not match any subscriber parameters, if filtering in S404 and S405 is executed, or simply if no subscription information is available for compiling in the direct route, no notification or other information may be provided back to the requesting source. Alternatively, filtering in S405 and/or providing in S408 may further include providing an indicator to the requesting source that no responsive subscription information is available for a patient. That is, regardless of other actions and treatment of healthcare information in example methods, a source's request for subscription information can be acted on with a separate compiling or alert of non-responsive information, regardless if the healthcare information is actually forwarded to a subscribing provider 160. By the same token, it is also possible that subscription information is provided back to a source only in the instance of a notification being provided to a subscriber in S409.

In S409, other operations and notifications may be performed, such as those described in other example methods below and in the incorporated documents. For example, the received, and potentially corrected and enhanced, healthcare information may be provided as a notification only to matching subscribing providers, potentially following processing and formatting. Healthcare notifications generated in S409 may include a wide variety of detail based on subscriber parameters and available healthcare information. For example, healthcare notifications may include only the ADT message content that triggered the notification, or healthcare notifications may include any or all healthcare information identified in MPI 31 for a patient whenever a responsive notification is generated for that patient. Subscriber parameters 120 may indicate a level and type of information requested in healthcare notifications; for example, a subscribing provider 160 may list internal identifiers, name of a primary care provider, record number, and/or any other contextual information to aid their bookkeeping that can be added into notifications by engine 114.

As another example of S409, logic core 113 may select particularly high-value or relevant healthcare data for inclusion in a notification. For example, an insurance provider can submit subscriber parameters 120 requesting notifications for treatment or prescription changes, and example embodiment system 100 may provide a notification to the provider each time an ADT message 35 contains an encounter with a changed treatment or prescription; the notification may also contain information about a new condition or hospital encounter that resulted in change if this information is determined as relevant or important, for, say, determining whether the new prescription is effective or wasteful, by the logic core 113. As discussed above, S409 may further include receiving an acknowledgement receipt from a subscriber 160, such as one using the Direct standard, in response to providing healthcare information.

Notification engine 114 can prepare healthcare notifications including data present solely in healthcare notification cluster 110, such as data stored in a local database that was filtered from ADT messages 35 and MPI 31 by logic core 113, or with information accessible anywhere in example embodiment system 100. For example, cluster 110 may have previously saved several different summary of care documents directly provided by an emergency room 50. Notification engine 114 may pull and combine all requested information among the previously-identified information in MPI 31 for presentation in a subscriber notification in S409.

Healthcare notifications may be delivered to subscribing providers 160 through a report 127 sent via email, over a direct or secure network, through the Direct standard, in HL7 format, via Internet services, or even hard copy, based on profile information. Healthcare notifications may be structured as narratives, tables, spreadsheets, existing encounter formats, etc. For example, a subscribing provider 160 may have requested a daily notification in HL7 format for a list of active patients in parameters 120, and notification engine 114 may compile and email out a report of all encounters in HL7 format for the identified patients within a daily interval.

Alternatively, in S409, healthcare notifications may be prepared and stored with notification engine 114 and provided to subscribing providers 160 only upon their access 128 to healthcare notification cluster 110; a reminder of a new healthcare notification may still be provided in this instance. Still further, a subscribing provider 160 may receive notifications via the Direct standard in real-time, permitting providers to readily follow-up with patients at each encounter, such as admission or discharge.

It is understood that several aspects of the methods possible from the flowchart of FIG. 3 are optional and may occur only in specific conditions. For example, only S400, S401, S404, and S405 may occur in the event of basic healthcare information filtering, such as when a CCDA from a healthcare provider 50 is received that does not match with any subscribing provider's parameters or an HL7 message that does not indicate an admit, transfer, or discharge is received. Or, for example, S400, S401, S402, S403, S404, S406, S407, S408, and S409 may all occur when healthcare information is received that is responsive to a subscriber's parameters, is eligible for correction based on additional information, requires further formatting prior to being sent out as defined by subscriber parameters, and the generating source requests subscription information. Several other action permutations are of course possible, including a direct S400 to S407 and S408 inquiry and providing without any other noticing of subscribers. As such, healthcare information sources may receive information about subscribers for patients in accordance with their requests through example methods.

As with all healthcare information sharing among separate parties, appropriate safeguards, including encryption and encoding, may be placed on any interface and transmission in example embodiments and methods. Similarly, because providers 50, HIEs 15, subscribers 160, cluster 110, and patients can all be distinct actors with independent owners and operators with distinct interests in healthcare information, appropriate consents and HIPAA-compliant releases may be secured or required from each such independent party before any information exchanging or usage is executed in any example method.

Some example methods being described here and in the incorporated documents, it is understood that one or more example methods may be used in combination and/or repetitively to produce multiple options and functionalities for subscribers. Example methods may be performed by properly programming or hardware configuring notification networks to receive healthcare information and subscriber information and act in accordance with example methods. Similarly, example methods may be embodied on non-transitory computer-readable media that directly instruct computer processors to execute example methods and/or, through installation in persistent memory, configure general-purpose computers connected to subscribers and healthcare information sources into specific healthcare notification networks that execute example methods.

Example methods and embodiments thus being described, it will be appreciated by one skilled in the art that example embodiments may be varied through routine experimentation and without further inventive activity. For example, information sources are described as a request to use cluster 110 as an information source on patients, it is understood that such a request may be automatically received in example embodiment networks for any subscriber through default options, a controlling ruleset, or through other independent operators and controllers. Variations are not to be regarded as departure from the spirit and scope of the exemplary embodiments, and all such modifications as would be obvious to one skilled in the art are intended to be included within the scope of the following claims.

What is claimed is:

1. A method of managing healthcare information with a notification system networked with a subscriber and a healthcare information source, the method comprising:
receiving, with a computer processor in the notification system, healthcare information from the healthcare information source;
determining, with the computer processor in the notification system, a same patient identified in the healthcare information and in subscriber parameters from a subscriber; and
providing, with the computer processor in the network, subscriber information to the healthcare information source, wherein the subscriber information identifies the subscriber having subscriber parameters identifying the same patient as in the healthcare information based on the determining.

2. The method of claim 1, wherein the source is a healthcare provider who generates the healthcare information in an encounter with the patient, and wherein the subscriber is independently operated from the healthcare provider.

3. The method of claim 1, further comprising:
receiving, at the notification system, the subscriber parameters including identifying information of the patient from the subscriber.

4. The method of claim 1, wherein the providing the subscriber information to the source is executed only if the healthcare information is for the patient in the subscriber parameters based on the determining.

5. The method of claim 1, wherein the subscriber information includes an identity of each subscriber having subscriber parameters that identify the patient.

6. The method of claim 1, wherein the healthcare information source is a healthcare provider, and wherein the healthcare information includes clinical feeds and a plurality of administrative messages generated by the healthcare provider.

7. The method of claim 6, further comprising:
providing, with the computer processor in the network, a notification to the subscriber only if the healthcare information is an administrative message indicating an admission, discharge, or transfer for the patient in the subscriber parameters based on the determining.

8. The method of claim 7, further comprising:
discarding clinical feeds and messages that lack an indication of an admission, discharge, or transfer.

9. The method of claim 1, wherein the healthcare information is a request from the source to provide subscription information for the patient.

10. The method of claim 9, wherein the request includes preferences for providing the subscriber information, and wherein the providing is executed at a time, format, and/or frequency in the preferences.

11. A method of managing healthcare information with a notification system networked with a plurality of subscribers and a plurality of healthcare information sources, the method comprising:
receiving, at the notification system, subscriber parameters identifying a plurality of patients from the subscribers;
receiving, with a computer processor in the notification system, a plurality of healthcare messages from the healthcare information sources;
determining, with the computer processor in the notification system, which subscriber parameters and healthcare messages identify a same patient; and
providing, with the computer processor in the network, for each matching subscriber parameter and healthcare message that identify the same patient based on the determining, an identity of the subscriber who provided the matching subscriber parameter to the source who provided the matching healthcare message.

12. The method of claim 11, wherein the healthcare information sources include a plurality of independent healthcare providers all connected to a single master patient index.

13. The method of claim 11, wherein the healthcare information sources include a healthcare provider who generates at least one of the healthcare messages in an encounter with the patient, and wherein the subscribers include an insurer of the same patient from the determining.

14. The method of claim 11, further comprising:
providing, for each matching subscriber parameter and healthcare message that identify the same patient based on the determining, a notification to the subscriber who provided the matching subscriber parameter, wherein the notification identifies the matching healthcare message.

15. The method of claim 14, wherein the identity of the subscriber provided to the source includes the notification provided to the subscriber.

16. The method of claim 14, healthcare messages include clinical feeds and administrative messages, and wherein the determining uses only admit, discharge, and transfer administration messages in determining which subscriber parameters and healthcare messages identify a same patient.

17. The method of claim 16, wherein the notification includes additional information over the matching healthcare message, and wherein the additional information is compiled based on the matching subscriber parameters.

18. The method of claim 11, further comprising:
receiving requests from the healthcare information sources for subscriber identification, and wherein the providing the identity is executed only if the matching source has submitted a request.

19. The method of claim 18, wherein the determining uses additional information added to the healthcare messages based on the subscriber parameters or a master patient index to determine which subscriber parameters and healthcare messages identify the same patient.

20. A computer processor networked with a healthcare information source and a subscriber, wherein the computer processor is configured to:
receive a healthcare message electronically transmitted from the healthcare information source;
determine a same patient identified in the healthcare information and in subscriber parameters from a subscriber; and
provide information about the subscriber having subscriber parameters identifying the same patient as the healthcare information to the healthcare information source, wherein the information identifies the subscriber.
